(19) United States
(12) Patent Application Publication
(10) Pub. No.: US 2016/0142883 A1
(43) Pub. Date: May 19, 2016

(54) Mobile Device Location Estimation Using Categorized Local Location Data From Various Sources

(71) Applicants: Jian Zou, Chapel Hill, NC (US); Yi Zou, Suining (CN)

(72) Inventors: Jian Zou, Chapel Hill, NC (US); Yi Zou, Suining (CN)

(21) Appl. No.: 14/542,549

(22) Filed: Nov. 15, 2014

(51) Int. Cl. H04W 4/02; H04W 48/16; H04W 64/00

(52) U.S. Cl. CPC H04W 4/028; H04W 4/023; H04W 64/003; H04W 48/16; H04W 88/16

(57) ABSTRACT

Methods and program products of mobile device location estimation using categorized local location data from various sources. For example, a method includes: detecting one or more wireless access gateways on a mobile device; for at least one detected wireless access gateway, determining whether or not location data of the gateway exists among part or all of a predetermined collection of data on the mobile device, the location data including a location estimate of the gateway, and none or at least one of: an uncertainty value associated with the location estimate; or a confidence value related to the likelihood that the gateway is stationary; determining whether or not a condition related to location estimation of the device is true; determining a location estimate of the device using the existing location data of the detected gateways on the device or other location estimation methods, based on the determination of the condition.

### TECHNICAL FIELD

This disclosure relates generally to geographic location determination.

### BACKGROUND

Mobile devices have become widely adopted by the public. Mobile devices include smart phones and feature phones, personal digital assistant (PDA) devices, tablets, laptops, wearable computing devices in various forms and other portable computing devices. Portable sensors capable of transmitting their readings wirelessly can be considered as mobile devices as well. Their mobility has given rise to numerous location-based functionalities and services implemented on them. A prerequisite to these functionalities and services is the ability of a mobile device to estimate its geographic location.

Various systems and methods can be used by a mobile device to estimate its location.

Some are based on navigation satellite. A mobile device can be equipped with one or more receivers of one or more global navigation satellite systems, such as the Global Positioning System (GPS). Such device can estimate its current location based on signals from relevant navigation satellites. Navigation satellite based methods require an unobstructed view of the sky to function properly. They work poorly or not at all when satellite signals are attenuated or interfered significantly (e.g. inside a building with thick walls). Associated latency, the delay from requesting a location estimate to obtaining it, can be significant. Required power consumption can be nontrivial.

Some are based on location server. A location server can be a system which is configured to provide a location estimate of a mobile device based on environmental information collected on the device. A location server can be remote or local.

Some use local location data of wireless signal emitters to perform location estimation. Local in this context means on the mobile device itself. Local location data of wireless signal emitters can have various components and each component can be in various formats. One component can be a location estimate of the emitter. Other component can be an uncertainty value associated with the location estimate, or a confidence value related to the likelihood that the emitter is stationary.

Local location data of a wireless signal emitter can be generated by the device. In some situations, the device can use a location estimate of the device at or around the time that the emitter's signals are detected on the device, together with an estimate of the closeness between the device and the emitter at that time, to generate local location data of the emitter.

When signals of one or more wireless signal emitters are detected on a mobile device and local location data of some or all of the emitters are available, the device may be able to estimate its location using those location data. Estimating location in this way could potentially have shorter latency and lower power consumption, or provide better location security and user privacy protection, or both, compared with methods based on navigation satellite or remote location server or a combination thereof.

### SUMMARY

Methods, program products, and systems of mobile device location estimation using categorized local location data from various sources are disclosed. In general, in one aspect, a mobile device can detect, on the device, one or more wireless access gateways. For at least one detected wireless access gateway, the device can determine whether or not location data of the wireless access gateway exists, among part or all of a predetermined collection of data on the mobile device. The location data includes a location estimate of the wireless access gateway, and none or at least one of: an uncertainty value associated with the location estimate; or a confidence value related to at least one of: the likelihood that the wireless access gateway is stationary; the likelihood that the true geographic location of the wireless access gateway is inside a geographic area defined by the location estimate; or the likelihood that the true geographic location of the wireless access gateway is inside a geographic area defined by the location estimate and the uncertainty value. The device can determine whether or not a condition related to location estimation of the mobile device is true.

The device can determine a final location estimate of the device, in response to the determination of the condition, using at least one of: a signal from a navigation satellite; data from another different computerized device; or a tentative location estimate of the device, determined using the existing location data on the mobile device of one or more of the detected wireless access gateways, and an estimate of a distance between the device and one of the detected wireless access gateways.

In some embodiments, the device can update the existing location data on the device, of at least one detected wireless access gateway, using at least one of: the final location estimate of the device; an uncertainty value associated with the final location estimate of the device; an estimate of a distance between the device and the detected gateway; or the existing location data on the device of the detected gateway.

In some embodiments, the device can create and store on the device, the location data of at least one of the detected wireless access gateways, using the final location estimate of the device; and none or at least one of: an uncertainty value associated with the final location estimate of the device; or an estimate of a distance between the device and the detected gateway.

The techniques described in this specification can be implemented to achieve the following exemplary advantages.

In some embodiments, when implemented and configured properly, they can potentially reduce the latency associated with mobile device location estimation using local location data. In some embodiments, when implemented and configured properly, they can potentially increase the chance that a valid location estimate of a mobile device is obtained using local location data, when the estimation is performed under a given time or power consumption constraint.

In some embodiments, when implemented and configured properly, under some circumstances, they can increase the likelihood that a location estimate of a mobile device can be determined using only information of detected wireless access gateways and local location data, without relying on navigation satellites or a remote location server. The benefit of location estimation using local location data, including shorter latency, reduced power consumption, better location security and better user privacy protection, can be realized to a larger extent as a result.

The details of one or more embodiments of mobile device location estimation using categorized local location data from various sources are set forth in the accompanying drawings and the description below. Other aspects, features, and advantages will become apparent from the description, the drawings and the claims.

### BRIEF DESCRIPTION OF DRAWINGS

FIG. 1 is a block diagram providing an overview of exemplary techniques of mobile device location estimation using categorized local location data from various sources.

FIG. 2 is a diagram illustrating one exemplary process for determining a tentative location estimate of a mobile device using location estimates in existing location data.

FIG. 3 is a flowchart of one exemplary process for determining a tentative location estimate of a mobile device and an associated uncertainty value, based on existing location data of detected wireless access gateways and the closeness values between the device and corresponding wireless access gateways.

FIG. 4 is a diagram illustrating one exemplary process of creating location data for a wireless access gateway using a location estimate of a mobile device, the uncertainty value associated with that estimate, and the closeness value between the device and the gateway.

FIG. 5 is a flow chart of one exemplary process of updating the location data of a wireless access gateway using a location estimate of a mobile device, the uncertainty value associated with that estimate, the closeness value between the device and the gateway, and the existing location data of the gateway.

FIG. 6 is a diagram illustrating one exemplary process of determining an intermediate location estimate of a mobile device and an uncertainty value associated with the intermediate estimate using the location data of a wireless access gateway and the closeness value between the device and the gateway.

FIG. 7 is a diagram illustrating one exemplary process of determining a tentative location estimate of a mobile device using two intermediate location estimates of the device.

FIG. 8 is a diagram illustrating one exemplary process of determining the location estimate and the associated uncertainty value in the updated location data of a wireless access gateway when a given condition is not true.

FIG. 9 is a flow chart of one exemplary process of categorizing one or more identifiers in a local location data store.

FIG. 10 is a block diagram illustrating exemplary techniques of building and updating server location data store using location data generated by mobile devices.

FIG. 11 is a block diagram illustrating functional components of a first exemplary location estimation system using categorized local location data from multiple sources.

FIG. 12 is a block diagram illustrating functional components of a second exemplary location estimation system using categorized local location data from multiple sources.

### DETAILED DESCRIPTION

### Overview of Mobile Device Location Estimation Using Categorized Local Location Data from Various Sources

In the following detailed description, numerous specific details are disclosed to provide a thorough understanding of some embodiments. However, it will be understood by persons of ordinary skills in the art that some embodiments may be practiced without those specific details. In some instances, well-known methods, procedures, components units have not been described in detail in order not to obscure the discussion. All embodiments described in this specification are embodiments.

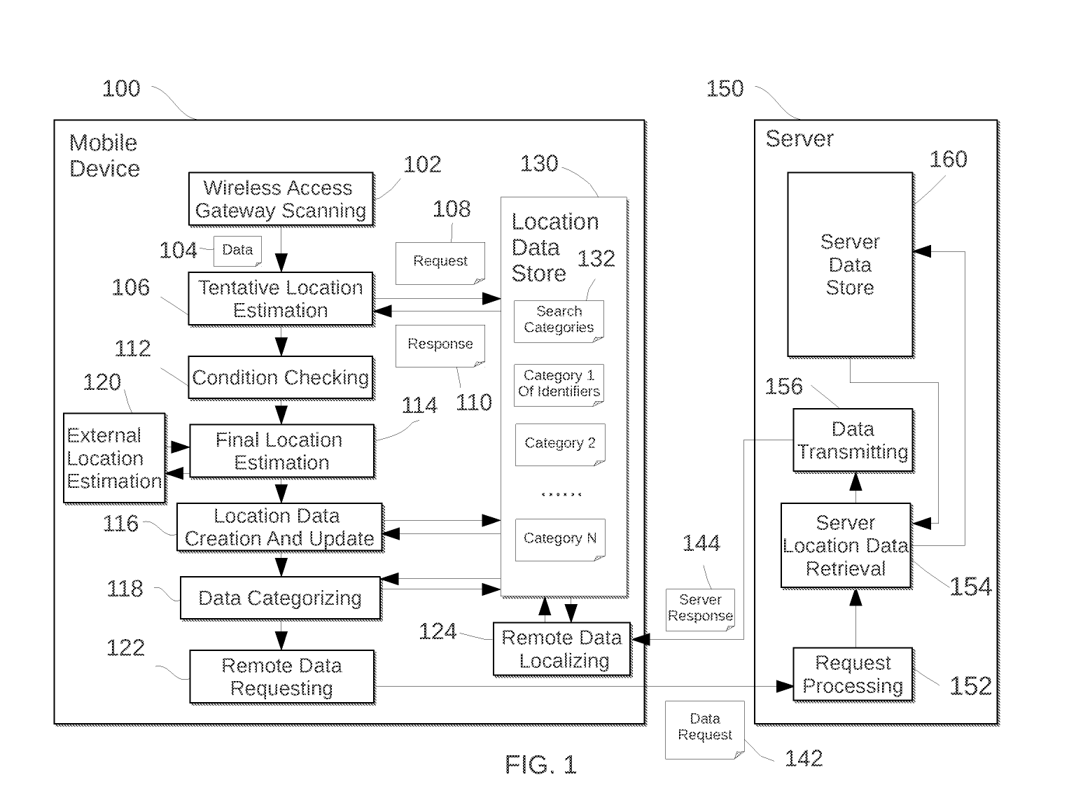

FIG. 1 is a block diagram providing an overview of exemplary techniques of mobile device location estimation using categorized local location data from various sources.

Mobile device 100 is an exemplary mobile device configured to estimate its location using categorized local location data from various sources. Device 100 can be a single mobile device, or a group of two or more communicatively connected mobile or non-mobile devices with at least one of them being a mobile device.

Device 100 can perform wireless access gateway scanning operations 102 to detect and measure wireless signals emitted by one or more wireless access gateways (e.g., cell towers, wireless routers, or other apparatus capable of emitting wireless signals). A wireless access gateway whose signals is detected or measured on device 100 can be referred to as a detected wireless access gateway. In some embodiments, scanning operations 102 can detect and measure signals from any number of wireless access gateways. In some embodiments, scanning operations 102 can detect and measure signals from up to a predetermined number of wireless access gateways. Scanning operations 102 can produce data 104. Data 104 can contain the identifiers of the detected gateways. An identifier of a wireless access gateway uniquely identifies the gateway. An identifier can include one or more of the following: identification information of a cell tower; media access control (MAC) address of a wireless router; or any other unique identification information of an apparatus capable of emitting wireless signals.

In some embodiments, for each detected gateway, scanning operations 102 can determine a closeness value for the gateway. Closeness values can be included in data 104. The closeness value for a detected gateway can represent an estimate of a distance between device 100 and the detected gateway. In some embodiments, the closeness value can be determined using a received signal strength indication (RSSI) measured at device 100 during scanning operations 102. In some embodiments, the closeness value can be determined using a round-trip time of a signal between device 100 and the gateway. In some embodiments, the closeness value can be determined using a bit error rate of a signal emitted by the gateway. In some embodiments, the closeness can be the maximum possible distance between the gateway and device 100 given the detected limit of related hardwares or software on device 100. Identifier and closeness value of a detected gateway can be represented as a key-value pair in data 104 with the key in the pair being the identifier and the value in the pair being the closeness value.

Device 100 can perform tentative location estimation operations 106 to determine a tentative location estimate of device 100. In some embodiments, estimation operations 106 can additionally determine an uncertainty value associated with the tentative location estimate.

### Local Location Data Store and Categories

Estimation operations 106 can first send request 108 to local location data store 130. Request 108 can include all or a portion of the identifiers in data 104. The number or maximum number of identifiers in request 108, p, can be predetermined. In some embodiments, the number of identifiers in data 104, n, can be larger than p. In that case, operations 106 can select p identifiers out of n identifiers in data 104 and put them in request 108. For example, operation 106 can select the p identifiers with the smallest closeness values. As another example, operation 106 can select p identifiers randomly out of the identifiers in data 104 with each identifier in data 104 having equal probability of being selected.

Store 130 can be implemented entirely on device 100 and can be configured to store identifiers of wireless access gateways and their location data. They can be stored on a persistent or non-persistent storage medium or a combination thereof. In some embodiments, store 130 can be configured to additionally store other information or data. In some embodiments, for each unique identifier in store 130, there can be one and only one location data related to its corresponding wireless access gateway stored in store 130. An identifier's corresponding is the wireless access gateway whose identifier matches the identifier. In some embodiments, for each unique identifier in store 130, there can be multiple location data of its corresponding wireless access gateway stored in store 130.

In some embodiments, for each unique identifier in store 130, store 130 can store time of last detection, or total detection count or both, of signals from its corresponding wireless gateway on device 100. A detection of signals from the wireless access gateway on device 100 can occur in operations 102, or in other unrelated operations performed on device 100, or both.

Identifiers in store 130 can be categorized. That is, there can be one or more predetermined categories for the identifiers in store 130, with each identifier belonging to one or more of such categories. Location data and other data related to a wireless access gateway stored in store 130 can be considered to belong to the same category as the gateway's identifier does. Each predetermined category can be represented by a unique predetermined category code, either numeric or symbolic. For example, a category code can be an integer or a string of alphanumeric characters.

In some embodiments, there is only one predetermined category to which all identifiers in store 130 belong to.

In some embodiments, there are two predetermined categories, active and inactive. Active category is represented by category code 1 and inactive category is represented by category code −1. In some embodiments, there are three predetermined categories, i.e. new, recent, and old, represented by category codes c1, c2 and c3 respectively.

In some embodiments, all possible locations of a wireless access gateway whose signals can be detected on device 100 can be partitioned into a predetermined set of non-overlapping geographic areas. Exemplary areas include ZIP code areas used by the United States Postal Service, time zones, administrative regions, countries, continents, hemispheres or other customarily defined areas. Each area within the set can define a category of identifiers in store 130. The category can be defined to include only those identifiers whose corresponding wireless access gateways are estimated to be located within the area. Its category code can be related to the area as well, such as ZIP code, postal Code, time zone offset from UTC, or state or country abbreviations or code.

When a wireless access gateway is estimated to be located at a geographic point on Earth, the gateway is estimated to be located within a given geographic area if and only if that point is within the given area. When a wireless access gateway is estimated to be occupying, or located somewhere within, a first geographic area on Earth, in some embodiments, the gateway is estimated to be within a given second geographic area if and only if the intersection between the first area and the second area is not empty, i.e. there exists some geographic points which belong to both the first area and the second area.

Each identifier in store 130 can belong to one or more categories. For convenience, the category or categories an identifier belongs to can be referred to as the identifier's category, or the category of the identifier in this specification.

In some embodiments, each identifier in store 130 can have a corresponding category-code list stored in store 130. The category-code list contains one or more category codes of the identifier's category. In some embodiments, the category of an identifier can be stored in a database table. Each row in the table can contain an identifier and the category code of one category the identifier in the row belongs to. Multiple rows with same identifier but different category codes can exist in the table and can represent that the identifier belongs to multiple categories. In some embodiments, the category of an identifier can be stored as key-value pairs in store 130. The key in a key-value pair can be the category code of a category the identifier belongs to and the value in the pair can be the identifier.

In some embodiments, an identifier's category can be represented by where it is stored or how it is stored in store 130. A predetermined storage region in store 130 can define a category of identifiers. The category can be defined to include only those identifiers stored within the storage region. For example, in some embodiments, more than one storage media exist in store 130. An identifier's category can be determined based on which medium or media the identifier or a copy of it is stored. As another example, in some embodiments, a storage medium in store 130 can be organized as an ordered sequence of storage units. A storage unit can be one byte or a predetermined number of continuous bytes. Each unit can have an integer address which represents its location or offset within the sequence of units. There can be a special section or part of the sequence, either continuous or not continuous, where only identifiers stored there belongs to a predetermined category. More specifically, in some embodiments, there are only two predetermined categories, active and inactive. An identifier in store 130 can be stored in one storage unit on a storage medium in store 130 which is organized into an ordered sequence of such storage units. The identifier has an integer address which is the index of the storage unit storing the identifier within the sequence. Active category can include only those identifiers whose address is even, or below a given integer threshold, t. Inactive category can include only those identifiers whose address is odd, or equal to or above t. One identifier can belong to more than one categories by having multiple copies of it stored in more than one storage locations.

In a first group of embodiments, the location data of a wireless access gateway can include a location estimate of the gateway. In a second group of embodiments, the location data of a gateway can include a location estimate of the gateway and an uncertainty value associated with the location estimate. In a third group of embodiments, the location data of a gateway can include a location estimate of the gateway and a confidence value. In a fourth group of embodiments, the location data of a gateway can include a location estimate of the gateway, an uncertainty value associated with the location estimate and a confidence value.

In some embodiments, the location estimate in the location data of a gateway can be represented by a geographic object. A geographic object can be a geographic point, geographic area, or a union (or intersection) of a finite collection of geographic points or geographic areas. A geographic point or area can be a point or area on Earth that can be uniquely and clearly defined to a person with ordinary skills in the art. For example, a geographic point can be represented by a latitude coordinate and a longitude coordinate. Some geographic area can be represented by a numerical or other code designating a predetermined geographic area (e.g. ZIP code and ZIP+4 code used by the United States Postal Service). Some geographic area can be represented by one or more geographic polygons expressed in various formats, such as GeoJSON specification for geometry primitives or multipart geometries (http://geojson.org/geojson-spec.html). The uncertainty value in the location data of a gateway can indicate an estimation accuracy of the location estimate with which it is associated. In some embodiments, the uncertainty value can be a value indicating a distance between a first geographic object representing the location estimate with which the uncertainty value is associated, and a second geographic object representing the true geographic location of the gateway. In some embodiments, the uncertainty value can be one or more numerical or other codes designating predetermined geographic areas.

Distance between two geographic objects can have various definitions. For example, it can be defined to be the minimum geographical distance between any two geographic points in the two geographic objects. Alternatively, it can be defined to be the maximum distance between any two geographic points in the two geographic objects. Various definitions of geographical distance between two geographic points exist in the art as well, such as a first one that is using great circle distance of two points on the Earth and assuming the Earth to be spherical with a known radius, or a second one assuming the Earth to be ellipsoidal. Any one can be used in a particular embodiment.

In some embodiments, the confidence value in the location data of a gateway can be related to one or more of the following: the likelihood that the gateway is stationary; the likelihood that its true geographic location is inside a geographic area defined by the location estimate in the location data; or the likelihood that its true geographic location is inside a geographic area defined by the location estimate and the uncertainty value associated with the estimate in the location data. In some embodiments, the confidence value can represent the likelihood that the gateway is stationary, and a distance between its true geographic location and the location estimate in the location data is less than or equal to the associated uncertainty value.

### Searching in Local Location Data Store

Upon receiving request 108, for each identifier in request 108, store 130 can search it against some or all identifiers in one or more categories in store 130 and determine whether or not a match is found for the identifier.

In some embodiments, for each identifier in request 108, store 130 can first determine the category or categories of identifiers in store 130 to search it against. In some embodiments, for an identifier in request 108, when there are two or more categories to be searched, all identifiers in one category are searched, before any identifier in another category is searched. Store 130 can determine the order by which those categories will be searched before searching operation starts. In some embodiments, searching an identifier in request 108 against two or more categories of identifiers in store 130 can be performed concurrently if device 100 supports concurrent computing. A match found in any category during the concurrent searching will terminate searching in all other yet-to-be-completed categories.

In some embodiments, for each identifier in request 108, the categories to search it against can be stored in search categories 132 in store 130. Categories 132 can be stored persistently in store 130 and can contain one or more category codes. In some embodiments, the order by which the category codes are listed in categories 132 can represent their order of being searching. For each identifier in request 108, store 130 can first read categories 132 and search the identifier against those categories in categories 132 and in the order by which they are listed. Categories 132 can be modified from one identifier to another in request 108, or during a later operation, such as local location data creation and update operations 116, data categorizing 118 or remote data localizing 124.

In some embodiment, for each identifier in request 108, the categories to search it against are predetermined and stay the same throughout the embodiment. For example, in some embodiments, only one category of identifiers, such as the active category, is searched against. In some embodiments, for each identifier in request 108, only two categories of identifiers, category new and category recent, out of three categories are searched against. In some embodiments, for each identifier in request 108, all categories in store 130 are searched against.

In those embodiments where each identifier in store 130 has a corresponding category-code list stored in store 130, for each identifier in request 108, store 130 can perform the search as follows. Store 130 first determine the categories to search the identifier against, either by reading categories 132 or based on predetermined categories. For every identifier in store 130, sequentially and one at a time, store 130 checks whether or not the identifier's category-code list contains the codes of one or more categories to search against. When it does, store 130 compares the identifier in store 130 against the one in request 108 to see if a match is found. The search for the identifier in request 108 is terminated when either a match is found, or all identifiers in store 130 have been checked.

In those embodiments where categories of identifiers are stored in a database table, for each identifier in request 108, store 130 can perform the search as follows. Store 130 first determines the categories to search the identifier against, either by reading categories 132 or based on predetermined categories. For every category to search against, store 130 selects all the rows in the table containing its corresponding category code. Store 130 then compares the identifier in request 108, against all identifiers in all selected rows for all categories to search against, sequentially and one at a time, until a match is found. The search for the identifier in request 108 is terminated when either a match is found, or all identifiers in all selected rows for all categories to search against have been compared against.

In those embodiments where categories of identifiers are stored in key-value pairs, for each identifier in request 108, store 130 can perform the search as follows. Store 130 first determines the categories to search the identifier against, either by reading categories 132 or based on some predetermined categories. For every category to search, store 130 selects all the key-value pairs with their keys being its corresponding category code. Store 130 then compares the identifier in request 108, against all identifiers in the values of all selected key-value pairs for all categories to search against, sequentially and one at a time, until a match is found. The search for the identifier in request 108 is terminated when either a match is found, or all identifiers in the values of all selected key-value pairs for all categories have been compared against.

In embodiments where an identifier's category is related to where it is stored, for each identifier in request 108, various search methods can be used. In some embodiments, for an identifier in request 108, store 130 can use linear search or sequential search. Linear search or sequential search can mean comparing a given identifier against every identifier among those being searched, one at a time and in sequence, until a match is found. In some embodiments where identifiers within each category are stored within a given storage area and are sorted, for each identifier in request 108 and each category, store 130 can perform a binary search or half-interval search for the identifier in that category. It will be understood by persons of ordinary skills in the art that binary search is a well known algorithm for searching for a specific value among a sorted array or list of values. It will also be understood by persons of ordinary skills in the art that other search methods or algorithms can also be used instead of binary or linear search.

Searching an identifier in request 108 against one or more categories of identifiers in store 130 can face other constraints. Some constraints can be based on the number of identifiers in store 130 that can be compared against the identifier in request 108. In some embodiments, for each identifier in request 108, the number of identifiers being searched against in store 130 can not exceed a predetermined threshold, such as 1000 or 1,000,000. In some embodiments, for each identifier in request 108, the number of identifiers being searched against in store 130 can not exceed a threshold that is dependent on the total number of identifiers in request 108. For example, such threshold can be the result of dividing a predetermined integer, such as 10,000,000, by the total number of identifiers in request 108. For each identifier in request 108, once the threshold is reached before a match is found, searching for the identifier terminates.

In some embodiments, for each identifier in request 108, searching for the identifier among some or all identifiers in store 130 can not take longer than a predetermined duration. In some embodiments, the predetermined duration is dependent on the total number of identifiers in request 108. For example, such duration can be the result of dividing another predetermined duration by the total number of identifiers in request 108. For each identifier in request 108, if when the predetermined duration is up before a match is found, searching for the identifier terminates.

The constraints can be caused by available resources on device 100 or other predetermined constraints or a combination thereof. In some embodiments, searching for a given identifier among some or all identifiers in store 130 requires one or more processors on device 100 to perform a number of mathematical or logical operations. Some search also requires a number of memory operations, such as reading data from persistent storage into memory. These operations on device 100 take time and consume power. The total number of operations, including mathematical, logical and memory operations, required to search all the identifiers in request 108 can be dependent on the number of identifiers in request 108, the search methods used by store 130, the number of identifiers in the categories being searched against, and other factors. In some embodiments, location estimation performed on device 100 has to be either completed within a given time, such as a maximum allowed latency, or aborted. As a result, searching for identifiers in request 108 by store 130 is subject to a time limit. Device 100 can have limited processing speed (i. e. maximum number of mathematical and logical operations that can be performed on device 100 in a unit of time) or limited power or both, and may not be able to perform all of the operations required in searching all identifiers in request 108 among all identifiers in store 130 within that time limit.

In some embodiments, for each identifier in request 108, store 130 can search it against an arbitrarily selected portion of the identifiers in store 130, without considering the categories they belong to. For example, for each identifier in request 108, store 130 can search the first given number (i.e. 1,000), of identifiers stored on a storage medium in store 130, with order of each identifier in store 130 is determined based on where it is stored, such as its storage address. If any other constraint is reached before a match is found, searching for the identifier terminates.

### Tentative Location Estimation

Store 130 can retrieve the location data, and other data if existing, of the identifiers in request 108 for which a match is found in store 130, and send response 110, containing the retrieved data, back to estimation operations 106. When no match is found for any identifier in request 108, no data is retrieved and response 110 can be empty. When more than one location data is associated with an identifier in store 130, store 130 can retrieve some or all the location data.

Estimation operations 106 can determine a tentative location estimate of device 100, based on location data in response 110.

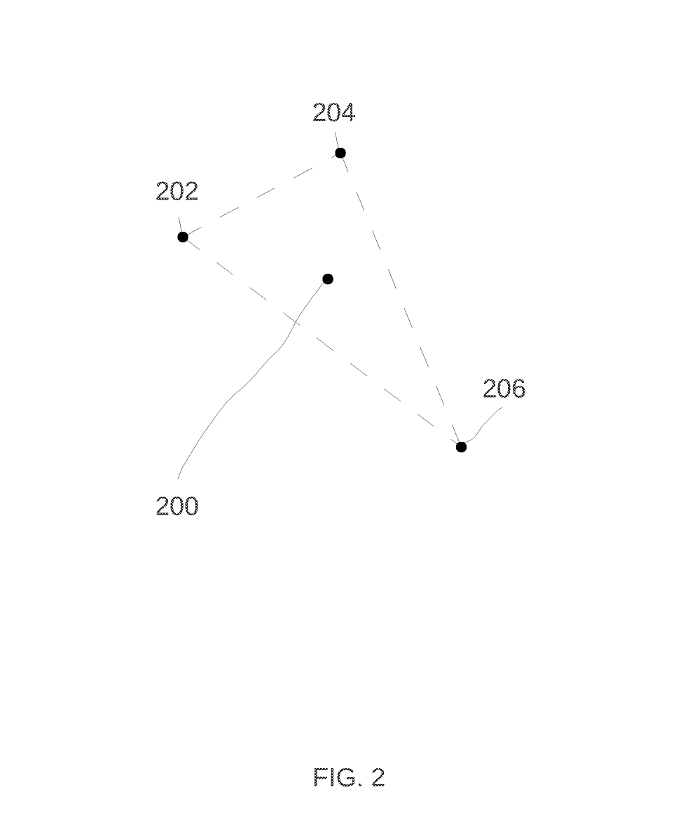

In the first group of embodiments, one exemplary process can be described as the following. Device 100 can determine the tentative location estimate to be an invalid location estimate which does not represent any geographic location on earth when response 110 contains no location data. In contrast, a valid location estimate represents a valid geographic object on Earth. In some embodiments, the invalid location estimate can have latitude coordinate outside the interval between −90 degrees and 90 degrees. In some embodiments, the invalid location estimate can be a numerical or other code designating a non-existing geographic area. Device 100 can determine the tentative location estimate to be the same as the location estimate in the only location data when only one location data is present in response 110. When two or more location data are present in response 110, device 100 can determine the tentative location estimate using all location data in response 110. In embodiments where the location estimate in the location data of a wireless access gateway includes a latitude coordinate and longitude coordinate, device 100 can determine the latitude coordinate and the longitude coordinate of the tentative location estimate to be the arithmetic mean of latitude coordinates and longitude coordinates in all location data in response 110, respectively. Further details of one exemplary process will be discussed below in reference to FIG. 2. In embodiments where the location estimate in the location data of a wireless access gateway includes a numerical or other code designating a predetermined geographic area, device 100 can determined the code in the tentative location estimate to be the one which appears most often in all location data in response 110. In embodiments where the location estimate in the location data of a wireless access gateway includes several latitude coordinates and longitude coordinates forming a polygon, device 100 can determine the latitude coordinate and the longitude coordinate of the tentative location estimate to be the arithmetic mean of all latitude coordinates and all longitude coordinates in all location data in response 110, respectively.

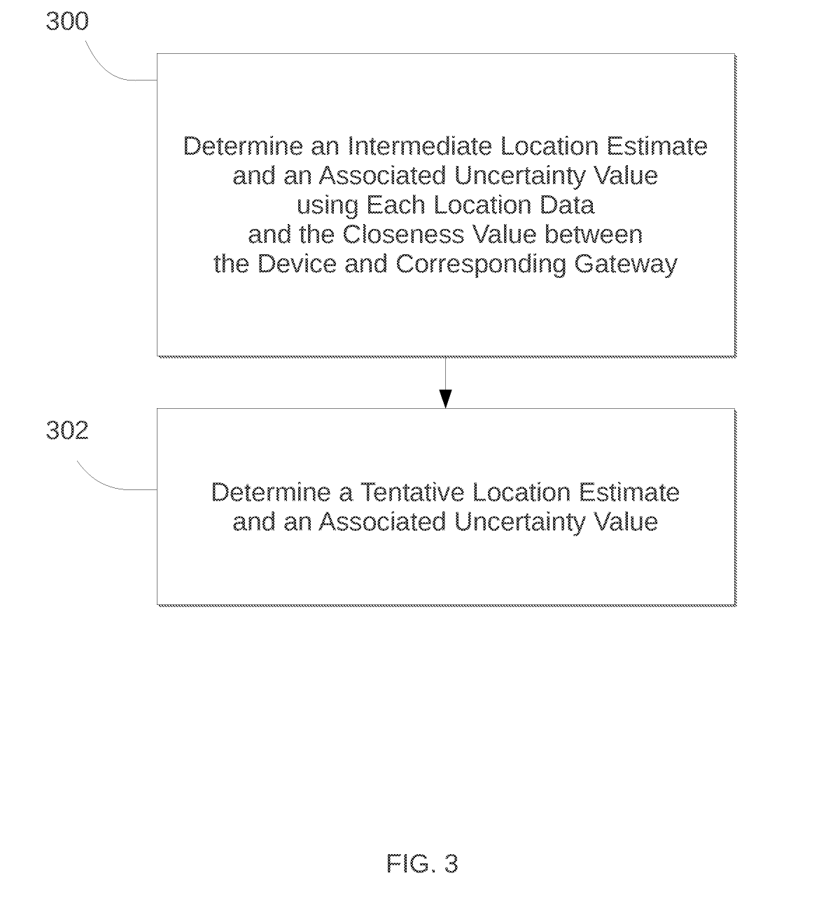

In the second group of embodiments, estimation operations 106 can additionally determine an uncertainty value associated with the tentative location estimate of device 100, based on location data in response 110 and the closeness values between device 100 and corresponding gateways in data 104. Further details of one exemplary process will be discussed below in reference to FIG. 3.

In the third group of embodiments, one exemplary process can be described as the following. For each location data in response 110, device 100 can determine whether or not it is meaningful by comparing the confidence value in the location data against a predetermined threshold. Device 100 can then determine the tentative location estimate through the exemplary process of estimation operations 106 for the first group of embodiments as described above, using only meaningful location data.

In the fourth group of embodiments, estimation operations 106 can additionally determine an uncertainty value associated with the tentative location estimate of device 100, based on the location data in response 110 and the closeness values between device 100 and corresponding gateways. One exemplary process can be described as the following. For each location data in response 110, device 100 can determine whether or not it is meaningful by comparing the confidence value in the location data against a predetermined threshold. Device 100 can determine the tentative location estimate and the associated uncertainty value through the exemplary process of estimation operations 106 for the second group of embodiments described above, using only meaningful location data.

### Condition Checking to Choose Route of Final Location Estimation

Condition checking operations 112 can determine whether or not a condition related to location estimation of device 100 is true. Boolean value of the condition is used to determine the source or method of a final location estimate of device 100. The final location estimate can be determined using either the tentative location estimate determined in operations 106, or methods other than the ones disclosed in this specification. Such methods can include navigation satellite based or remote location server based methods. This condition is in addition to, and different from, a first condition that match of at least one identifier in data 104 is found among part or all identifiers in store 130. It is also different from, a second condition that the tentative location estimate obtained in operations 106 exists and is valid. In some embodiments, the condition can be true or false when the second condition is true.

In some embodiments, checking operations 112 can determine the condition to be true when a condition value determined based on location data in response 110 satisfies a predetermined constraint.

For the first group of embodiments, one exemplary process of checking operations 112 can be described as the following. Device 100 can determine a condition value to be 1000 when there is no location data in response 110 and −1 when there is only one location data in response 110. Device 100 can determine the condition value to be the largest distance between two location estimates in any two location data in response 110. Device 100 can determine the condition to be true when and only when the condition value is less than a predetermined value, e.g. 500.

For the second group of embodiments, one exemplary process of checking operations 112 can be described as the following. Device 100 can determine a condition value to be 1 when there is no location data in response 110 and −1 when there is only one location data in response 110. Device 100 can determine a first value to be the largest distance between two location estimates in any two location data in response 110 and a second value to be the sum of the two uncertainty values associated with the two location estimates, when there are two or more location data in response 110. Device 100 can determine the condition value to be the result of the first value subtracting the second value when there are two or more location data in response 110. Device 100 can determine the condition to be true when and only when the condition value is less than 0.

For the third and fourth group of embodiments, one exemplary process of checking operations 112 can be described as the following. For each location data in response 110, device 100 can determine whether or not it is meaningful by comparing the confidence value in the location data against a predetermined threshold. Device 100 can determine a condition value to be the smallest confidence value among those in meaningful location data in response 110 or 0 when there is no meaningful location data in response 110. Device 100 can determine the condition to be true when and only when the condition value is greater than a predetermined value, e.g. 0.5.

For the fourth group of embodiments, another exemplary process of checking operations 112 can be described as the following. For each location data in response 110, device 100 can determine whether or not it is meaningful by comparing the confidence value in the location data against a predetermined threshold. Device 100 can determine whether or not the condition is true through the exemplary process of checking operations 112 for the second group of embodiments described above, using only meaningful location data.

In some embodiments, checking operations 112 can determine the condition to be true when a random value satisfies a predetermined constraint. The random value can have a probability distribution function or probability density function that is either predetermined or influenced by the location data in response 110. One exemplary process of checking operations 112 can be described as the following. Device 100 can generate a random number, r, with uniform distribution over the interval between 0 and 1, inclusive of both 0 and 1. Device 100 can determine the condition to be true when and only when r<0.95.

For the third and fourth group of embodiments, one exemplary process of checking operations 112 can be described as the following. Device 100 can determine a value m to be the maximum confidence value among those in the location data in response 110 or 1 when there is no location data in response 110. Device 100 can determine a value n to be the total number of wireless access gateways whose location data are present in response 110. Device 100 can determines a value, z, to be z=m^{(0.03×n)}. Device 100 can generate a random number, r, with uniform distribution over the interval between z−1 and z, inclusive of both z−1 and z. Device 100 can determine the condition to be true when and only when r is less than zero, i.e. r<0.

When the condition is determined to be true in checking operations 112, final location estimation operations 114 can determine a final location estimate of device 100 using the tentative location estimate as determined in estimation operations 106. In the second and fourth group of embodiments, device 100 can determine the uncertainty value associated with the final location estimate of device 100 using the uncertainty value associated with the tentative estimate.

When the condition is determined to be false in checking operations 112, estimation operations 114 can determine the final location estimate of device 100 using external location estimation operations 120. Estimation operations 120 can determine a location estimate of device 100 using any location estimation method other than the ones disclosed in this specification. In some embodiments, estimation operations 120 can use a navigation satellite based method or a remote location server based method or a combination of the two. Estimation operations 114 can determine the final location estimate using the location estimate as determined in estimation operations 120. In the second and fourth group of embodiments, estimation operations 120 can additionally determine an uncertainty value associated with the location estimate of device 100. Estimation operations 114 can additionally determine an uncertainty value associated with the final location estimate of device 100 using the uncertainty value determined in estimation operations 120.

### Creating and Updating Local Location Data

In some embodiments, for each identifier in data 104 that is absent in store 130, location data creation and update operations 116 can store the identifier and create and store a corresponding location data in store 130.

In some embodiments, operations 116 starts after operations 114 is completed and is not subject to a time constraint such as maximum allowed latency. Determining whether or not an identifier in data 104 is absent or present in store 130 can use any of the search method described before to search the identifier, against all identifiers in store 130. In some embodiments, for each identifier in data 104 which is absent in store 130, operations 116 can additionally generate and store a time of last detection and a total detection count in store 130. The time of last detection can be set to be the time when operations 102 ends and the total detection count can be set to be 1.

For the first group of embodiments, operations 116 can determine the location estimate in the created location data using the final location estimate of device 100 as determined in estimation operations 114.

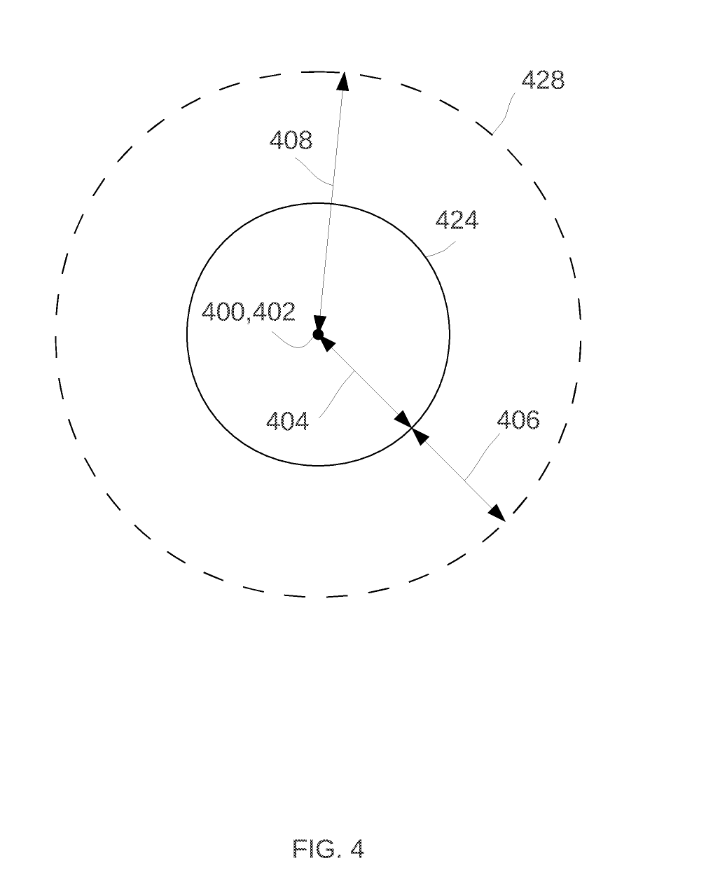

For the second group of embodiments, for each identifier in data 104 that is absent in store 130, operations 116 can first retrieve, from data 104, its closeness value. Operations 116 can then determine the location estimate and the associated uncertainty value in the created location data of the identifier, using the final location estimate of device 100 and the associated uncertainty value as determined in final location estimation operations 114, and its closeness value retrieved from data 104. Further details will be discussed below in reference to FIG. 4.

For the third group of embodiments, creation and update operations 116 can determine the location estimate in the created location data using the final location estimate of device 100. Device 100 can determine the confidence value in the created location data of the gateway to be a predetermined default numerical value between 0 and 1, or a predetermined numerical value between 0 and 1 based on the category of the gateway (e.g. cell tower or wireless router or others), or a numerical value between 0 and 1 determined based on other information related to the gateway. One exemplary process can be described as the following. Device 100 can determine the confidence value to be 0.9999 when a gateway is a cell tower, 0.99 when a gateway is a wireless router or 0.95 when the gateway is something else.

For the fourth group of embodiments, operations 116 can determine the location estimate and the associated uncertainty value in the created location data following the exemplary process of operations 116 for the second group of embodiments as described above. Operations 116 can determine the confidence value in the created location data of the gateway following the same exemplary process of operations 116 for determining the confidence value for the third group of embodiments as discussed above.

In some embodiments, for each identifier in data 104 which is present in store 130, operations 116 can update one or more of its existing corresponding location data in store 130.

For the first group of embodiments, operations 116 can determine the location estimate in an updated location data of the gateway using the final location estimate of device 100.

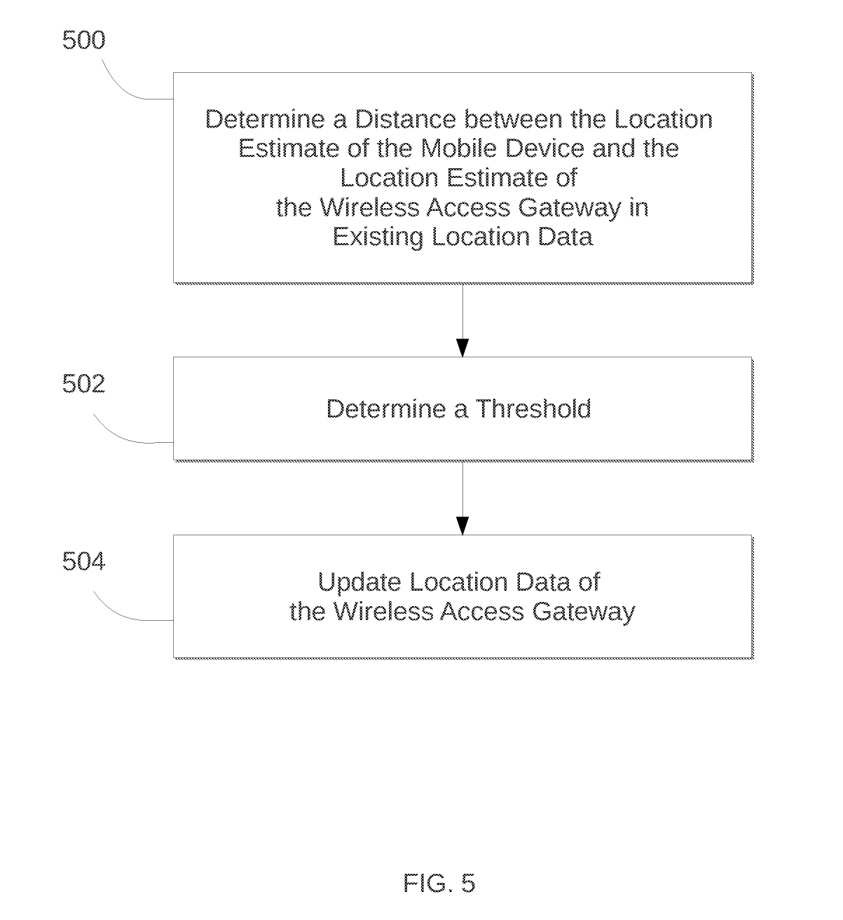

For the second group of embodiments, operations 116 can determine the location estimate and the associated uncertainty value in an updated location data of the gateway using the final location estimate of device 100 and the associated uncertainty value as determined in final location estimation operations 114, and the closeness value between device 100 and corresponding gateway as determined in scanning operations 102 and the existing location data of the gateway being updated in store 130. Further details will be discussed below in reference to FIG. 5.

For the third group of embodiments, operations 116 can determine the location estimate in the update location data of the gateway using the final location estimate of device 100 as determined in final location estimation operations 114. In embodiments where the confidence value is a numerical value between 0 and 1, one exemplary process of determining the confidence value in the updated location data can be described as the following. Device 100 can determine a distance, d, between the location estimate in the updated location data of the gateway and the location estimate in the existing location data of the gateway being updated in store 130. Device 100 can determine the confidence value in updated location data, m₂, to be

$${m}_{2} = \frac{{c}_{1} \times {m}_{1}}{( {c}_{1} \times {m}_{1} + {c}_{2} \times ( 1 - {m}_{1} ) )}$$

where m₁ is the confidence value in the existing location data of the gateway being updated in store 130, c₁ is a predetermined value which indicates the probability density of the distance being d when the gateway is stationary, and c₂ is another predetermined value which indicates the probability density of the distance being d when the gateway is mobile.

For the fourth group of embodiments, operations 116 can determine the location estimate and the associated uncertainty value in an updated location data of the gateway through the exemplary process of operations 116 for the second group of embodiments as described above. In embodiments where the confidence value is a numerical value between 0 and 1, one exemplary process can be described as the following. Device 100 can determine a distance, d, between the location estimate in the updated location data of the gateway and the location estimate in the existing location data of the gateway being updated. Device 100 can determine a dislocation ratio, r_{d}, to be the distance divided by the sum of, the uncertainty value in the existing location data of the gateway being updated, uₒ, and the uncertainty value in the updated location data,

$${u}_{n} , i . e . {r}_{d} = \frac{d}{( {u}_{o} + {u}_{n} )} .$$

Device 100 can determine the confidence value in the updated location data, m₂, to be

$${m}_{2} = \frac{{c}_{1} \times {m}_{1}}{( {c}_{1} \times {m}_{1} + {c}_{2} \times ( 1 - {m}_{1} ) )}$$

where m₁ is the confidence value in the existing location data of the gateway being updated, c₁ is a predetermined value which indicates the probability density of the dislocation ratio being r_{d} when the gateway is stationary and its true geographic location is inside a geographic area defined by the location estimate and the associated uncertainty value in the existing location data, and c₂ is another predetermined value which indicates the probability density of the dislocation ratio being r_{d} when the gateway is mobile or its true geographic location is outside the geographic area.

In some embodiments, for each identifier in data 104 which is present in store 130, operations 116 can additionally update its time of last detection and total detection count in store 130. The time of last detection can be set to be the time when operations 102 ends and the total detection count can be incremented by 1.

### Categorizing Local Location Data

Data categorizing operations 118 can determine the category of none, some or all identifiers in store 130. In some embodiments, operations 118 can determine the category of only those identifiers in data 104. In some embodiments, operations 118 can determine the category of all identifiers in store 130.

In some embodiments, operations 118 can first determine whether or not a condition is true, the condition being a valid final location estimation is obtained in operations 114. Categorization of identifiers is only performed when the condition is determined to be true. When the condition is determined to be false, no further operation is performed in operations 118.

In some embodiments, operations 118 can determine the category of an identifier without considering other identifiers in store 130.

In some embodiments, the category of an identifier in store 130 can be determined as a result of a random process. For example, there are only two possible categories, active and inactive. For an identifier in store 130, a random number n of uniform distribution over interval 0 and 1, inclusive of both 0 and 1, can be generated on device 100. If n is greater than 0.5, the identifier is determined to belong to the active category. Otherwise, the category it belongs to is inactive.

In some embodiments, the category of an identifier in store 130 can be determined deterministically, based on information or traits of the identifier, or of its corresponding wireless access gateway. For example, in embodiments where categories correspond to geographic areas, the category of an identifier can be determined to include all such categories that the identifier's corresponding wireless access gateway is estimated to be located within their geographic areas. Such category can be found by checking the location estimate against each category's geographic area, sequentially and one at a time.

In some embodiments, the category of an identifier in store 130 can be determined based on the confidence value or uncertainty value in its location data. For example, when confidence value in its location data is below a predetermined threshold, e.g. 0.5, the identifier is determined to be in the mobile category. When the confidence value is between two predetermined values, e.g. 0.5 and 0.8, the identifier is determined to be in the ambiguous category. When the confidence value is above a predetermined threshold, e.g. 0.8, the identifier is determined to be in the stationary category.

In some embodiments, operations 118 can determine the category of an identifier after taking into account other identifiers in store 130. For example, the category of the identifier can be dependent on the relative ranking among all identifiers in store 130. In some embodiment, there are three categories of identifiers in store 130, category I, II and III. An identifier is categorized based on its total detection count. Category I includes only those identifiers whose total detection counts are in 70^{th} percentile. Category II includes only those identifiers whose total detection counts are in 40th percentile but not in 70^{th} percentile. Category III includes the rest.

In some embodiments, operations 118 can determine the category of an identifier in light of size limits of certain categories in store 130. For example, in some embodiments, there are two categories, an active category in store 130 with a size limit 1,000,000 and an inactive category with no size limit. A size limit of a category can mean that the number of identifiers in the category at once can not exceed that limit. In this embodiment, for each identifier in data 104, operations 118 can categorize it into the active category when its size limit is not reached. When the size limit is reached, operations 116 can rank all the identifiers in the active category and the identifier in data 104 based on a certain criteria. The criteria can be an estimated distance from an identifier's corresponding gateway to the final location estimate determined in operations 114. Larger distance results in lower rank. Ranks among identifiers with same distance can be arbitrary. Operations 118 can then categorize one with the lowest rank into the inactive category and categorize the rest into the active category.

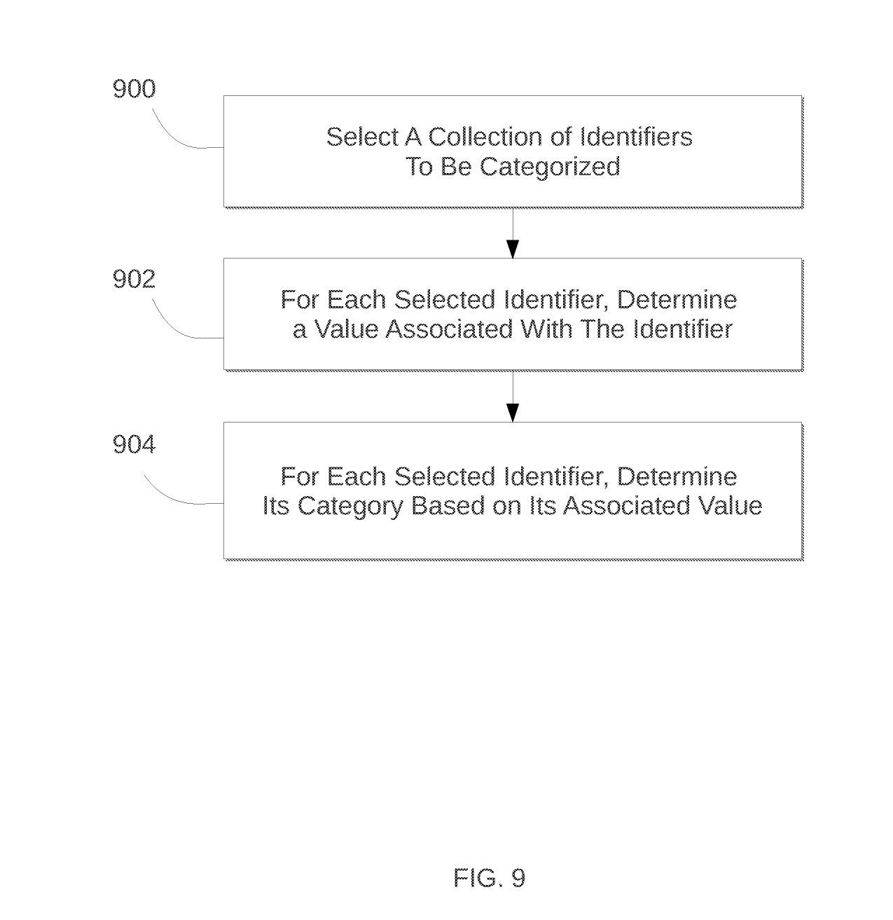

In some embodiments, the category of an identifier in store 130 can be determined using information of its corresponding wireless access gateway stored in 130 including time of last detection or total detection count or both. An exemplary process will be discussed in detail below in reference to FIG. 9.

In some embodiments, operations 118 can remove one or more identifiers from a category in store 130 to make room for other identifiers.

For example, in some embodiments, a category of identifiers in store 130 has a predetermined size limit and the number of identifiers within that category has already reached that limit. In that case, in order to comply with the size limit, one identifier has to be removed from the category before another identifier can be categorized into that category. Various strategies can be used for selecting the identifier to be removed. A first strategy could be selecting the identifier arbitrarily. A second strategy could be first in and first out (FIFO). When using FIFO, the order by which each identifier is added to the category is recorded. In the case that one or more identifiers need to be removed from the category, the one or ones which were added to the category first or the earliest will be removed. A third strategy could be removing identifier based on ranking. All identifiers within a category can be ranked based on a certain criteria. For example, the criteria can be based on an estimated distance between the identifier's corresponding wireless access gateway and the final location estimate obtained in operations 114, with larger distance resulting in lower ranking.

Operations 118 can store the created or updated category of an identifier in store 130.

In embodiments where the category of an identifier in store 130 is stored in its category-code list, for each identifier being categorized, operations 118 can add the codes of the category of the identifier to its category code list if they are not already there. Removing an identifier from a category can be done by removing the category's code from the identifier's category-code list.

In embodiments where the category of an identifier in store 130 is related to where it is stored in store 130, after the category of an identifier has been determined, operations 118 can store the identifier in or move the identifier to an appropriate address or addresses consistent with the category it is determined to be in. Removing an identifier from a category can be done by moving the stored identifier from an address to another different address, or by removing a copy of it at a certain place.

In embodiments where the category of an identifier in store 130 is stored in a database table or key-value pairs, once the category of an identifier has been determined, operations 118 can create database table rows or key-value pairs containing the identifier and the code of its category and store them in store 130 accordingly. Removing an identifier from a category can be done by removing the row containing the identifier and the category's category code from the table, or by removing the key-value pair with the key in the pair being the category's category code and the value in the pair being the identifier.

In embodiments where search categories 132 exists in store 130, operations 118 can update categories 132.

In some embodiments, categories 132 determines the categories that will be searched against next time when operation 106 is performed, and an order among those categories by which the search will be performed. In embodiments where categories in store 130 correspond to geographic areas, operations 118 can change categories 132 to only include the categories whose geographic areas are within a predetermined distance from the final location estimate of device 100 obtained in operations 114. Order among those categories within categories 132 can be random, arbitrary or determined based on a certain criteria, such as an estimated distance between their corresponding geographic areas and the final location estimate of device 100.

### Request Data from Server

Device 100 can optionally perform remote data requesting operations 122. Operations 122 can be performed only when device 100 is communicatively connected with server 150. Server 150 can be the second source of local location data in store 130, in addition to or instead of, the first source which is device 100 itself, as described in operations 116. In some embodiments, server 150 can be the only source of local location data in store 130. In those embodiments, operations 116 does not perform any operation.

In some embodiments, operations 122 can first determine whether or not requesting data from server 150 is possible and needed. If requesting data from server 150 is determined to be not possible or not needed, no further operations is performed in operations 122. In some embodiments, determination of possibility of requesting data from server 150 can be based on whether device 100 can communicate with server 150. For example, device 100 can send a predetermined data packet under a predetermined communications protocol (e. g. Internet Control Message Protocol) to server 150. Device 100 then waits for a fixed period of time to see if a response from server 150 is received. If the response is received within the period of time, device 100 can determine requesting data from server 150 to be possible. Otherwise not possible. It is understood by persons of ordinary skills in the art that many other methods known in the art can also be used to determine whether device 100 can communicate with another computing device.

In some embodiments, an exemplary process of determining whether or not requesting data from server 150 is needed can be described as follows. Operations 122 first determines whether or not a first condition that a valid final location estimate is obtained in operations 114 is true. If the first condition is true, operations 122 can determine whether or not a second condition that the minimum distance between that final location estimate and all location data within store 130 exceeds a predetermined threshold is true. If the second condition is also true, operations 122 can determine requesting data is needed and generate data request 142 which contains the final location estimate. Request 142 can additionally contain an integer which can be a fraction of the number of identifiers in one or more categories in store 130, such as one tenth. If the second condition is not true, operations 122 can determine requesting data is not needed and no further operation is performed in operations 122. If the first condition is not true, operations 122 can determine a third condition that one or more identifiers exist in data 104 is true or not. If the third condition is true, operations 122 can determine requesting data is needed and generate request 142 which contains one or more of the identifiers in data 104. In some embodiments, request 142 may additionally contain an integer specifying the number of identifiers whose data are requested. If the third condition is not true, operations 122 can determine requesting data is not needed and no further operation is performed in operations 122.

In some embodiments, operations 122 can determine that requesting data from server 150 is needed when the uncertainty value associated with the final location estimate determined in operations 114 exceeds a predetermined threshold. Request 142 can contain either the final location estimate or one or more of the identifiers in data 104.

In some embodiments, determination of whether requesting data is needed can be based on some information gathered from other sources on device 100 or remotely. For example, operations 122 can scan a calendar, event planner or the like on device 100 for future events that a user of device 100 is scheduled to be at. Device 100 can determine whether or not a fourth condition that location information of an event the user of device 100 is scheduled to be at in the future can be obtained is true. For example, device 100 can determine the fourth condition by checking an location item or the like of each unexamined entry in one predetermined calendar on device 100 and to see if it is empty. After examination, device 100 mark that entry to be examined. When at least one of them is not empty, device 100 determine fourth condition to be true. When all unexamined entries have empty location item, device 100 can determine fourth condition to be false. In those embodiments, device 100 can determine requesting data from server 150 is needed only when fourth condition is determined to be true.

When device 100 determines requesting data from server 150 is needed, requesting operations 122 can generate and send data request 142 to server 150. Request 142 can contain different types of information in different embodiments. In some embodiments, each type of information can be represented in a predetermined format unique to that type. In some embodiments, a type indicator, which is a numeric or symbolic code, can be included in request 142 to help server 150 to identify the type of information in request 142.

In some embodiments, the type of information in request 142 can be location estimates of device 100, such as the final location estimate of device 100 obtained in operations 116, previous location estimates of device 100 or a combination thereof. In some embodiments, the type of data in request 142 can be identifiers of wireless access gateways, such as those whose signals are detected on device 100 during operations 102. In some embodiments, request 142 can contain an integer, indicating the amount of data requested, or the maximum number of wireless access gateways whose identifiers and location data should be sent back in server response 144. Such integer can be a given fraction of the number of identifier in the categories being searched against in operation 106. For example, it can be one-tenth of the number of identifiers in the active category.

In some embodiments where information gathered on device 100 is used to determine that requesting data from server 150 is needed, request 142 can contain those information, represented in various formats, such as JSON. For example, request 152 can contain {“future_location”: [“123 Main Street, Smallville, XY, USA”, “1000 Long Drive, Somewhere, Some Province, Some Country in the World”, “XYZ Building, ABC Corporation”]}.

Request 142 can be transmitted over a communications network to server 150. Request 142 can be encrypted, authenticated or otherwise processed, using an appropriate protocol or framework that is known or will be known in the art, during the transmission process to ensure its anonymity, authenticity, completeness or other properties. In some embodiments, to defend against potential eavesdroppers, request 142 can be first encrypted using the public key in a predetermined public-private key pair. A cipher version of request 142 can be transmitted over a network to server 150. Server 150 can use the private key in the public-private key pair to decrypt the cipher version and obtain the plaintext version of request 142. In some embodiments, the following protocol can be implemented to ensure the authenticity and completeness of request 142 received by server 150. Device 100 can apply a predetermined hash function to request 142 to obtain a digital signature of request 142. An exemplary predetermined hash function can be one from the Secure Hash Algorithm (SHA) hash function family as defined by U.S. Federal Information Processing Standards (e. g. FIPS PUB 180-4). Device 100 can encrypt the digital signature using the private key in a predetermined public-private key pair to obtain a cipher signature. Device 100 can transmit both plaintext request 142 and the cipher signature to server 150. Upon receiving both request 142 and an associated cipher signature, server 150 can use the public key in the public-private key pair to decrypt cipher signature to obtain a plaintext signature. Server 150 can apply the same predetermined hash function to the plaintext request 142 received and compare the output against the plaintext signature. If they are the same, then the authenticity and completeness of request 142 can be verified. If they are not the same, the authenticity and completeness of request 142 can be rejected. In some embodiments, to provide anonymity, request 142 can be transmitted over a Tor network or one employing onion routing on its way to server 150.

It will be understood by persons of ordinary skills in the art that many other protocols, methods and systems known in the art can be used or implemented to provide or ensure anonymity, authenticity, completeness, or other properties of request 142 received by server 150.

Server 150 can refer to a single computing device with memory and storage medium, or a group of two or more communicatively connected computing or storage devices.

Server 150 contains server data store 160. Store 160 can be implemented entirely on server 150 and can be configured to store data of wireless access gateways, including identifiers and location data of those gateways. In some embodiments, store 160 can store large amount of such data, far more than the amount in store 130 on device 100.

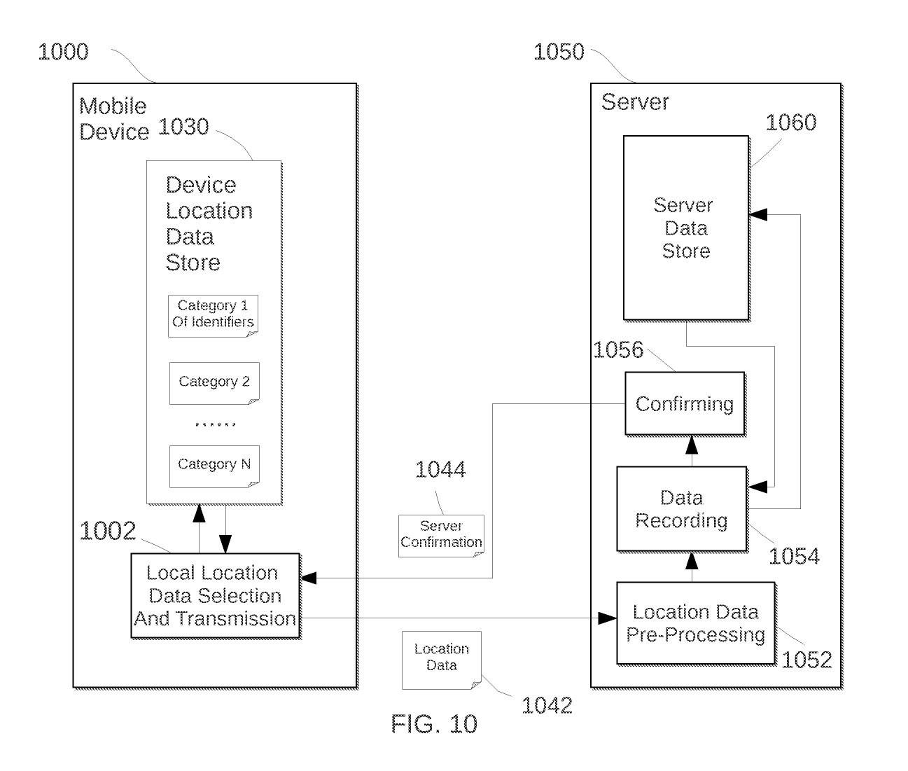

In some embodiments, data in store 160 can be obtained through a predetermined database, such as one maintained by Wireless Geographic Logging Engine (https://wigle.net). In some embodiments, data in store 160 can be obtained by collected location data generated by device 100 and other similar devices capable of generating location data of wireless access gateways. A block diagram illustrating exemplary techniques of building and updating server location data store 160 using location data generated by mobile devices will be described in detail in reference to FIG. 10.

Server 150 can perform request processing operations 152 on request 142 upon receiving it. Operations 152 can first identify the types of information included in request 142. In some embodiments, such identification can be performed by determining the format of data in request 142. In some embodiments, the identification can be performed by reading the type indicator in request 142.

### Location Data Selection and Retrieval on Server

Server 150 can perform server location data retrieval operations 154 to retrieve data of wireless access gateways from store 160.

Operations 154 can be different for different types of information in request 142. In embodiments where an integer is included in request 142, operations 154 can retrieve data of a number of wireless access gateways from store 160. The number is no greater than the integer in request 142. In embodiments where no amount of requested data is specified in request 142, operations 154 can retrieve data of a predetermined number of wireless access gateways.

Identifiers and location data of wireless access gateways stored in store 160 can have same components or formats as those in store 130. In some embodiments, identifiers and location data in store 160 can be categorized. In those embodiments, categories of identifiers in store 160 can be defined and stored in the same or similar ways as those in store 130. An identifier's category in store 160 can be determined in a same or similar way as that on device 100 and described above, if such way is applicable on server 150. Methods to categorize an identifier requiring a location estimate of device 100 are not applicable on server 160. Others are, such as those based on information or traits of an identifier's corresponding gateway. An identifier's category can be updated and the update can be implemented in same or similar way as that described above on device 100, if such way is applicable on server 150.

In some embodiments, operations 154 can first select a group of candidate data, including candidate identifiers and their location data from store 160. The number of identifiers in the group can be less than or equal to the total number of identifiers in store 160. For example, in some embodiments, identifiers in store 160 are categorized based on the confidence values in their location data, and a stationary category in store 160 includes all identifiers whose corresponding confidence values exceed a predetermined threshold. In those embodiments, operations 154 can select the group of candidate data to include data of some or all wireless access gateways whose identifiers are in the stationary category. The group of candidate data can be subject to a predetermined size limit, such as the number of wireless access gateways whose data are in the group is no greater than a predetermined number.

Operations 154 can select data of gateways to be retrieved from store 160 according to various strategies. A few strategies will be described in detail as follows. In some strategies discussed below, operation 154 can select data to be retrieved only from the group of candidate data.

In embodiments where request 142 contains one location estimate and optionally an integer, for each identifier in the group of candidate data, operations 154 can determine a distance between a location estimate in its corresponding location data and the location estimate in request 142. Operations 154 can then select data of a number of wireless access gateways from the group of candidate data, whose identifiers have the shortest distances among those in the group of candidate data. The number can be a predetermined integer or the integer in request 142.

In those embodiments described in the paragraph above, after determining the distance for each identifier in the group of candidate data, alternatively, operations 154 can select a first group of data of all wireless access gateways whose identifiers' distances are below a predetermined threshold. Operations 154 can then select data of a number of wireless access gateways randomly, with or without replacement, from the first group of data, with each data having equal or not equal chance of being selected and the number being a predetermined integer, or the integer in request 142.

In embodiments where request 142 contains more than one location estimates (e. g. current location estimate and previous location estimates of device 100) and optionally an integer, operations 154 can perform the same operations as described in the two paragraphs above to select data to be retrieved, except that the distance for each identifier in the group of candidate data, is determined to be an average distance or a minimum distance between a location estimate in the identifier′ corresponding location data and all location estimates in request 142.

In embodiments where request 142 contains one or more identifiers of wireless access gateways, for each identifier in request 142, operations 154 can first search store 160 to determine if a match of the identifier can be found among identifiers in store 160. If yes, the match's location estimate in its corresponding location data is retrieved. When at least one identifier in request 142 has a match in store 160, operations 154 then select data in the same way as described above, with one or more location estimate in request 142 being replaced by the retrieved location estimates of the identifiers for which a match is found in store 160. When no identifier in request 142 has a match in store 160, operations 154 can retrieve no data.

In embodiments where request 142 contains location information in other formats, such as address or name of a place or a geographic region, operations 154 can first use geocoding to determine one or more geographic coordinates representing or related to the location information in 142. It will be understood by persons of ordinary skills in the art that geocoding is a well-known process in the art and numerous systems and methods for doing so exist in the art. Any such method known or will be known in the art in the future can be implemented or used here. Operations 154 can then select data in the same way as described above, with the location estimates in request 142 being replaced by the geographic coordinates obtained through geocoding process.

Server 150 can transmit all data of wireless access gateways selected and retrieved in operations 154 to device 100, as server response 144, in data transmitting operations 156.

### Server Response Processing on Mobile Device

Upon receiving server response 144, device 100 can perform remote data localizing operations 124. Operations 124 can create or update data in store 130 using server response 144. In some embodiments, operations 124 can additionally categorize part or all the identifiers in store 130.

For each identifier in server response 144 that is absent in store 130, operations 124 can create data in store 130 by storing the identifier and its corresponding location data in store 130. For each identifier in server response 144 that is present in store 130, operations 124 can update its location data in store 130 by replacing its existing corresponding location data in store 130 with its corresponding location data in response 144. In the third and fourth groups of embodiments, for each identifier in server response 144 that is present in store 130, operations 124 can update its location data in store 130 by following the process of updating existing location data within operations 116 for those two groups of embodiments, respectively, with the following modifications. The closeness value between device 100 and corresponding gateway is set to be 0. The final location estimate of device 100 and associated uncertainty value are replaced by location estimate of the identifier and associated uncertainty value in response 144, respectively.

### Some Optional Operations

In some embodiments, when the condition is determined to be not true in condition checking operations 112, and when external location estimation operations 120 can not determine a location estimate of device 100, final location estimation operations 114 can determine the final location estimate of device 100 using the tentative location estimate as determined in tentative location estimation operations 106.

In some embodiments, store 130 can be configured to store additional data including time instants, identifiers of wireless access gateways detected at those time instants and closeness values between device 100 and corresponding detected gateways at those time instants.

### Details of Exemplary Processes

FIG. 2 is a diagram illustrating one exemplary process for determining a tentative location estimate of a mobile device using location estimates in existing location data.

Device 100 can determined the latitude coordinate and the longitude coordinate of tentative location estimate 200 of device 100 to be the arithmetic mean of latitude coordinates and longitude coordinates in location estimates 202, 204, 206, respectively.

FIG. 3 is a flowchart of one exemplary process for determining a tentative location estimate of a mobile device and an associated uncertainty value, based on existing location data of detected wireless access gateways and the closeness values between the device and corresponding wireless access gateways.

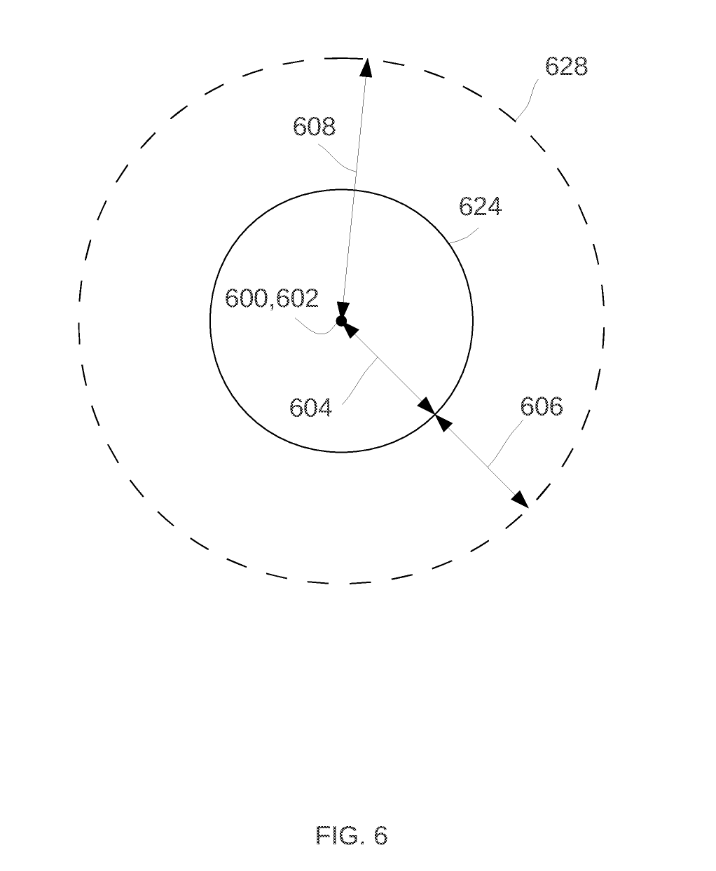

Device 100 can determine 300 an intermediate location estimate of device 100 and an associated uncertainty value using each location data in response 110, and the closeness value between device 100 and corresponding gateway. One exemplary process of 300 will be discussed in further details below in reference to FIG. 6.

Device 100 can determine 302 a tentative location estimate of device 100 and an associated uncertainty value using each intermediate location estimate of device 100 and the associated uncertainty value as determined in 300.

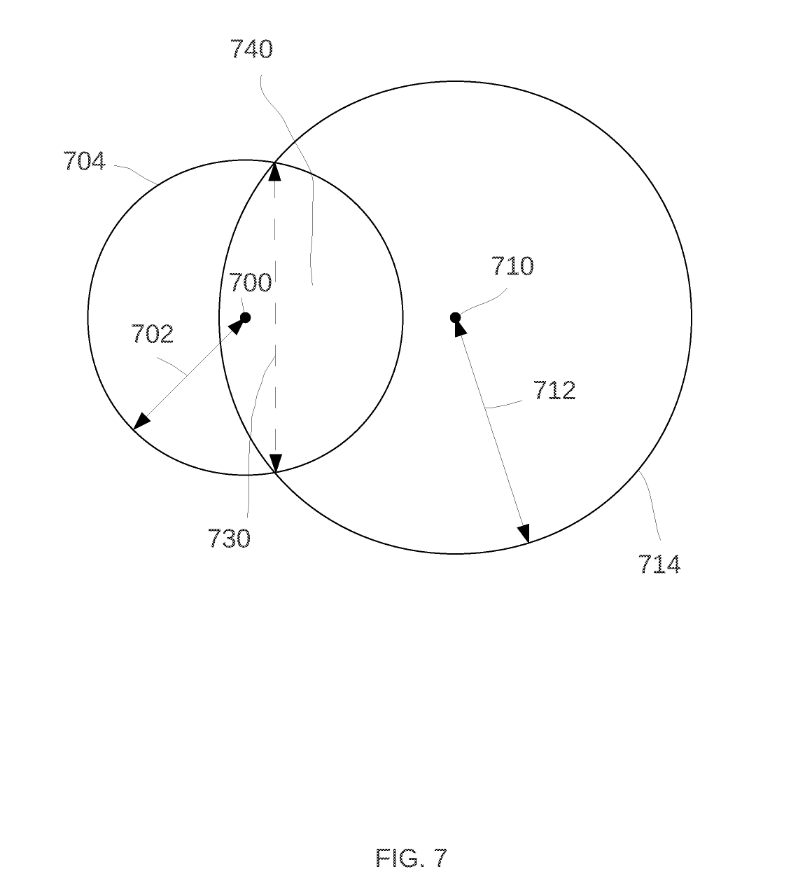

Device 100 can determine the tentative location estimate to be an invalid location estimate when no intermediate location estimate of device 100 can be determined in 300. Device 100 can determine the latitude coordinate and the longitude coordinate in the tentative location estimate to be the same as the latitude coordinate and the longitude coordinate in the only intermediate location estimate respectively, when only one intermediate location estimate of device 100 can be determined in 300. When two or more intermediate location estimates of device 100 can be determined in 300, device 100 can determine a geographic area, where the distance between any point in the area and each intermediate location estimate of device 100 is less than or equal to the uncertainty value associated with that intermediate location estimate. Device 100 can determine the tentative location estimate to be the geographical center of the area, and the associated uncertainty value to be half of the diameter of the area, when such area is not empty. Device 100 can determine the tentative location estimate to be any one of the intermediate location estimates of device 100, and the associated uncertainty value to be the corresponding uncertainty value, when such area is empty. An example of determining a tentative location estimate using two intermediate location estimates of device 100 is illustrated below in reference to FIG. 7.

FIG. 4 is a diagram illustrating one exemplary process of creating location data for a wireless access gateway using a location estimate of a mobile device, the uncertainty value associated with that estimate, and the closeness value between the device and the gateway.

In some embodiments, device 100 can determine the latitude coordinate and the longitude coordinate in location estimate 400 in the created location data of the gateway to be the same as the latitude coordinate and the longitude coordinate in location estimate 402 of device 100, respectively. As a result, estimate 400 and estimate 402 are represented by the same point on FIG. 4. Device 100 can determine the uncertainty value associated with estimate 400 in the created location data of the gateway, r_{g}, represented by radius 408 of circle 428, to be the sum of, the uncertainty value associated with estimate 402, rₘ, represented by radius 404 of circle 424, and the closeness value between device 100 and the gateway, d, represented by distance 406, i.e. r_{g}=rₘ+d.

FIG. 5 is a flow chart of one exemplary process of updating the location data of a wireless access gateway using a location estimate of a mobile device, the uncertainty value associated with that estimate, the closeness value between the device and the gateway, and the existing location data of the gateway.

Device 100 can determine 500 a distance between the final location estimate of device 100 and the location estimate in the existing location data of the gateway in response 110.

Device 100 can determine 502 a threshold to be the sum of, the uncertainty value associated with the final location estimate of device 100, the uncertainty value in the existing location data of the gateway, and the closeness value between device 100 and the gateway.

Device 100 can update 504 the existing location data of the gateway, based on the distance and the threshold. One exemplary process of 504 can be described as following.

Device 100 can determine whether or not a condition is true, the condition being the distance is greater than or equal to the threshold. When the condition is true, device 100 can determine the latitude coordinate and longitude coordinate, in the location estimate of the updated location data to be the same as the latitude coordinate and longitude coordinate in the final location estimate of device 100. Device 100 can determine the uncertainty value in the updated location data to be the sum of, the uncertainty value associated with the final location estimate of device 100, and the closeness value between device 100 and the gateway.

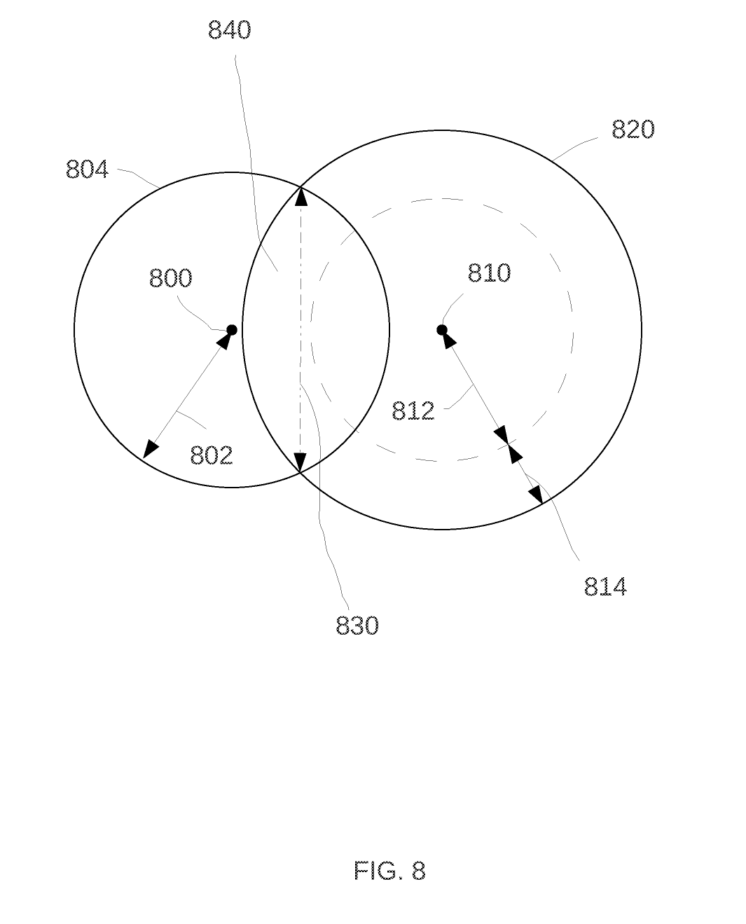

When the condition is not true, one exemplary process for determining the location estimate and the associated uncertainty value in the updated location data of the gateway can be described below in reference to FIG. 8.

FIG. 6 is a diagram illustrating one exemplary process of determining an intermediate location estimate of a mobile device and an uncertainty value associated with the intermediate estimate using the location data of a wireless access gateway and the closeness value between the device and the gateway. Device 100 can determine the latitude coordinate and the longitude coordinate in the intermediate location estimate 600 of device 100 to be the same as the latitude coordinate and the longitude coordinate in location estimate 602 in the location data, respectively. As a result, estimate 600 and estimate 602 are represented by the same point on FIG. 6. The uncertainty value associated with estimate 600, rₘ, represented by radius 608 of circle 628, can be determined to be the sum of, the uncertainty value associated with estimate 602, r_{g}, represented by radius 604 of circle 624, and the closeness value between device 100 and the gateway, d, represented by distance 606, i.e. rₘ=r_{g}+d.

FIG. 7 is a diagram illustrating one exemplary process of determining a tentative location estimate of a mobile device using two intermediate location estimates of the device. Device 100 can determine the geographic area where the distance between any point in the area and intermediate location estimate 700 is less than or equal to the associated uncertainty value, r₁, represented by radius 702 of circle 704, and the distance between any point in the area and intermediate location estimate 710 is less than or equal to the associated uncertainty value, r₂, represented by radius 712 of circle 714, to be intersection 740. Intersection 740 can be the intersection between the disk enclosed by circle 704 and the disk enclosed by circle 714. Device 100 can determine the tentative location estimate to be the geographical center of intersection 740 and the uncertainty value associated with the tentative estimate to be half of diameter 730 of intersection 740.

FIG. 8 is a diagram illustrating one exemplary process of determining the location estimate and the associated uncertainty value in the updated location data of a wireless access gateway when a given condition is not true.

Device 100 can determine a first geographic area defined by final location estimate 810 of device 100, and an uncertainty value which is the sum of, the uncertainty value associated with estimate 810 as represented by radius 812, and the closeness value between device 100 and the gateway, as represented by distance 814, to be the disk enclosed by circle 820. Device 100 can determine a second geographic area defined by location estimate 800 in the existing location data of the gateway, and the associated uncertainty value, as represented by radius 802, to be the disk enclosed by circle 804. Device 100 can determine a third geographic area 840 to be the intersection between the first geographic area and the second geographic area. Device 100 can determine the location estimate in the updated location data to be the geographical center of area 840 and the associated uncertainty value in the updated location data to be half of diameter 830 of area 840.

FIG. 9 is a flow chart of one exemplary process of categorizing one or more identifiers in a local location data store.

Device 100 can select 900 a collection of identifiers to be categorized. In some embodiments, all identifiers in store 130 can be selected. In some embodiments, only those without existing categories are selected. Yet in some other embodiments, only a portion of identifiers in store 130 are selected, either randomly, deterministically, or arbitrary. In embodiments where storage area for identifiers on a storage medium is known, an example of random selection can be described as follows. Device 100 can randomly generate a group of storage addresses within the storage area. Device 100 can then select those identifiers stored at those addresses. Deterministic selection can be based on traits, categories or other information about an identifier or its corresponding wireless gateway. For example, device 100 can select all the identifiers whose source is server 150 and have not been detected on device 100 yet.

For each selected identifier, device 100 can determine a value associated with the identifier. In some embodiments, the value can be determined to be the geographic distance between the location estimate in the identifier's corresponding location data in store 130 and a geographic location. In some embodiments, the value can be determined to be the identifier's corresponding wireless access gateway's total detection count. In some embodiments, the value can be determined to be the length of time since time of last detection for its corresponding wireless access gateway. In some embodiments, the value can be determined to be the result of a mathematical operations with one or more of the above as operands. For example, the value c can be determined to be c=N^{-0.001t} where N is the total detection count and t is the time in hours that has passed since time of last detection.

For each selected identifier, device 100 can determine its category based on its associated value. For example, device 100 can determine that a given number of identifiers with highest values among those selected belong to category I. As another example, device 100 can determine the identifier's category to be category II when its associated value is below a predetermined threshold. As yet another example, device 100 can determine its category to be category III when the value is within a predetermined interval, i.e. the value is less than or equal to a first predetermined value and greater than or equal to a second predetermined value with the second value smaller than the first.

### Building and Updating Server Data Store

FIG. 10 is a block diagram illustrating exemplary techniques of building and updating server location data store using location data generated by mobile devices.

Mobile device 1000 can be a device same as or functionally equivalent to device 100 in FIG. 1. Device location data store 1030 can be implemented entirely on device 1000 and be configured to store the same data and perform the same operations as store 130 in reference to FIG. 1. In some embodiments, in addition, store 1030 can store a flag or boolean value for each identifier in store 1030, indicating whether its location data has been sent to server 1050. Every time the location data of an identifier is created or changed, its flag or boolean value can be set to be false. Every time after the location data of an identifier has been transmitted to server 1050 and a predetermined confirmation sent by server 1050 is received on device 1000, its flag or boolean value can be set to be true.

Device 1000 can perform local location data selection and transmission operations 1002. In some embodiments, operations 1002 can select all identifiers in store 1030. In some embodiments, operations 1002 can select those identifiers whose flags are false. Operations 1002 then transmit all the selected identifiers, their location data and, other related data if existing in store 1030, as location data 1042 over a communications network to server 1050. In some embodiments, data 1042 can additionally include some identification information of device 1000, such as MAC address of one or more wireless network adaptor on device 1000, model and serial number of device 1000 provided by its manufacturer, International Mobile Equipment Identity, Mobile Equipment Identifier, the like or a combination thereof.

Data 1042 can be encrypted, authenticated or otherwise processed, using an appropriate protocol or framework that is known or will be known in the art, during the transmission process to ensure its anonymity, authenticity, completeness or other properties. In some embodiments, to defend against potential eavesdroppers, data 1042 can be first encrypted using the public key in a predetermined public-private key pair. A cipher version of data 1042 can be transmitted over a network to server 1050. Server 1050 can use the private key in the public-private key pair to decrypt the cipher version and obtain the plaintext version of data 1042. In some embodiments, the following protocol can be implemented to ensure the authenticity and completeness of data 1042 received by server 1050. Device 1000 can apply a predetermined hash function to data 1042 to obtain a digital signature of data 1042. An exemplary predetermined hash function can be one from the Secure Hash Algorithm (SHA) hash function family as defined by U.S. Federal Information Processing Standards (e. g. FIPS PUB 180-4). Device 1000 can encrypt the digital signature using the private key in a predetermined public-private key pair to obtain a cipher signature. Device 1000 can transmit both plaintext data 1042 and the cipher signature to server 1050. Upon receiving both data 1042 and an associated cipher signature, server 1050 can use the public key in the public-private key pair to decrypt cipher signature to obtain a plaintext signature. Server 1050 can apply the same predetermined hash function to the plaintext data 1042 received and compare the output against the plaintext signature. If they are the same, then the authenticity and completeness of data 1042 can be verified. If they are not the same, the authenticity and completeness of data 1042 can be rejected. In some embodiments, to provide anonymity, data 1042 can be transmitted over a Tor network or one employing onion routing on its way to server 1050.

It will be understood by persons of ordinary skills in the art that many other protocols, methods and systems known in the art can be used or implemented to provide or ensure anonymity, authenticity, completeness, or other properties of data 1042 received by server 1050.

Server 1050 can be a server same as or functionally equivalent to server 150 in FIG. 1. Server 1050 can perform location data pre-processing operations 1052 upon receiving data 1042. Operations 1052 can check the authenticity, completeness, or other properties of data 1042 as described above. In some embodiments, operations 1052 can extract the identification information of device 1000 from data 1042 and check it against a predetermined white list, i. e. a set of such identification information, stored in server data store 1060. Only data 1042 from a device for which a match of its identification information is found in the white list will be processed further. For others, operations 1054 and 1056 are not performed.

Server 1050 can perform data recording operations 1054. For each identifier in data 1042, operations 1054 can first check whether or not a match to the identifier exists in store 1060. In some embodiments, store 1060 can store all the information stored in store 160 in reference to FIG. 1. In some embodiments, store 1060 can additionally store the white list described before. If the match exists, operations 1054 updates its corresponding location data and other data if existing in store 1060. An exemplary updating process can be the same as the location data updating process in operations 124 in FIG. 1, with store 130 being replaced by store 1060 and server response 144 being replaced by location data 1042. If the match does not exist, operations 1054 can create the identifier and its location data in store 1060 by storing the identifier and its location data in data 1042 into store 1060.

Server 1050 can perform confirming operations 1056 upon completion of operations 1054. Operations 1056 can send a predetermined confirmation, such as a predetermined data packet, using a predetermined communications protocol to device 100. One example of a predetermined communications protocol can be TCP/IP ir ICMP.

### Functional Components of a First Exemplary Location Estimation System Using Categorized Local Location Data from Multiple Sources

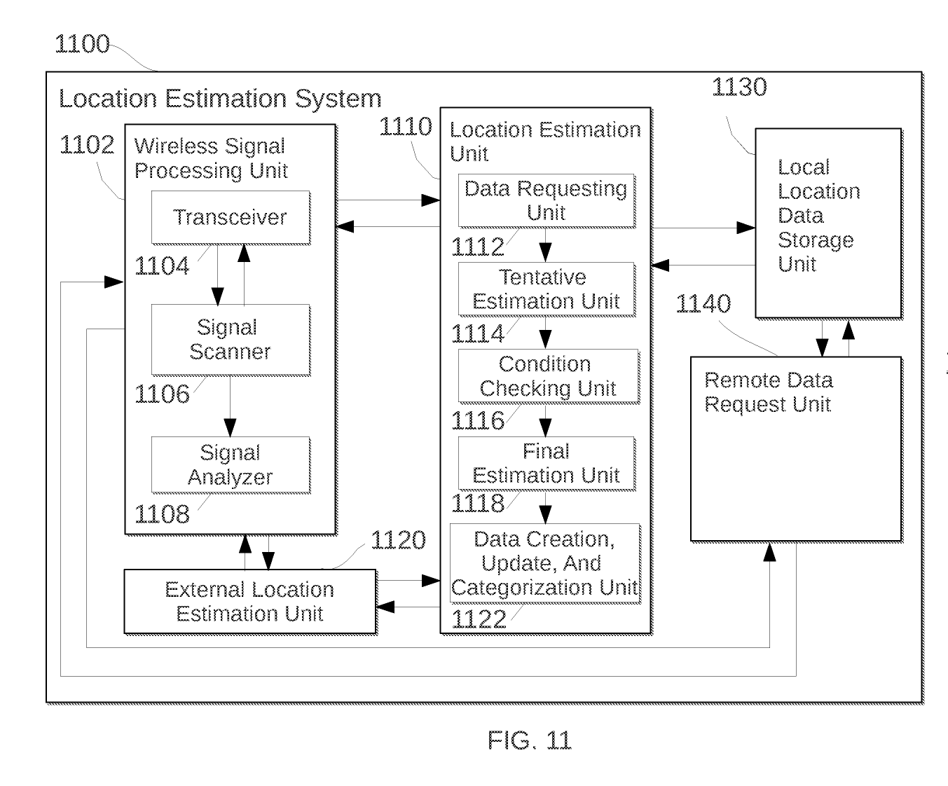

FIG. 11 is a block diagram illustrating functional components of a first exemplary location estimation system using categorized local location data from multiple sources. System 1100 can be a component of device 100 as described above in reference to FIG. 1.

System 1100 can include local location data storage unit 1130. Unit 1130 can be a non-transitory data storage component of system 1100 that is configured to store identifiers, location data, and optionally other data such as time of last detection, total detection count and a flag, of wireless access gateways and perform other operations required for location data store 130. In some embodiments, unit 1130 can be configured to store additional data such as time instants, identifiers of detected wireless access gateways, closeness values between system 1100 and detected gateways.

System 1100 can include wireless signal processing unit 1102. Unit 1102 can include at least one of: a processor for processing signals from a cell tower, a wireless processor (e.g., a WiFi™ chip) for processing signals from a wireless router, or a processor for processing other kinds of wireless signals. Unit 1102 can include transceiver 1104. Transceiver 1104 is a component of unit 1102 that is configured to send and receive wireless signals. Unit 1102 can include signal scanner 1106 and signal analyzer 1108. Scanner 1106 is a component of unit 1102 that is configured to cause transceiver 1104 to scan one or more communication channels to detect wireless signals from wireless access gateways (cell towers or wireless routers or others). The signals can include the identifiers of the wireless access gateways. Analyzer 1108 is a component of unit 1102 that is configured to analyze the detected wireless signals and determine the round trip time, the bit error rate, received signal strength indicator (RSSI) or other information that can indicate a closeness value between system 1100 and the corresponding gateway. The closeness value can represent an estimate of a distance between system 1100 and the gateway.

Unit 1102 can send the identifiers of the detected wireless access gateways, as well as the information that can indicate the closeness values, to location estimation unit 1110. Unit 1110 is a component of system 1100 that is configured to determine a location estimate of system 1100. Unit 1110 can include an application processor and computer instructions for controlling the application processor. Unit 1110 can include data requesting unit 1112. Unit 1112 can be a component of unit 1110 that is configured to request location data of each detected wireless access gateways using the identifiers sent by unit 1102. Unit 1112 can send the identifiers to unit 1130 and receive location data and optionally other data from unit 1130.

Unit 1110 can include tentative estimation unit 1114. Unit 1114 is a component of unit 1110 that is configured to perform tentative location estimation operations 106.

Unit 1110 can include condition checking unit 1116. Unit 1116 is a component of unit 1110 that is configured to perform condition checking operations 112.

Unit 1110 can include final estimation unit 1118. Final estimation unit 1118 is a component of unit 1110 that is configured to perform final location estimation operation 114.

Unit 1110 can include data creation, update, and categorization unit 1122. Unit 1122 is a component of unit 1110 that is configured to perform location data creation and update operations 116, data categorizing operations 118.

System 1100 can include external location estimation unit 1120. Unit 1120 can be a component of system 1100 that is configured to perform external location estimation operations 110. Unit 1120 can interact with unit 1102.

System 1100 can optionally include remote data requesting unit 1140. Unit 1140 can be a component of system 1100 that is configured to perform remote data requesting operations 122 and remote data localizing operations 124. Unit 1140 can interact with unit 1102.

### Functional Components of a Second Exemplary Location Estimation System Using Categorized Local Location Data from Multiple Sources

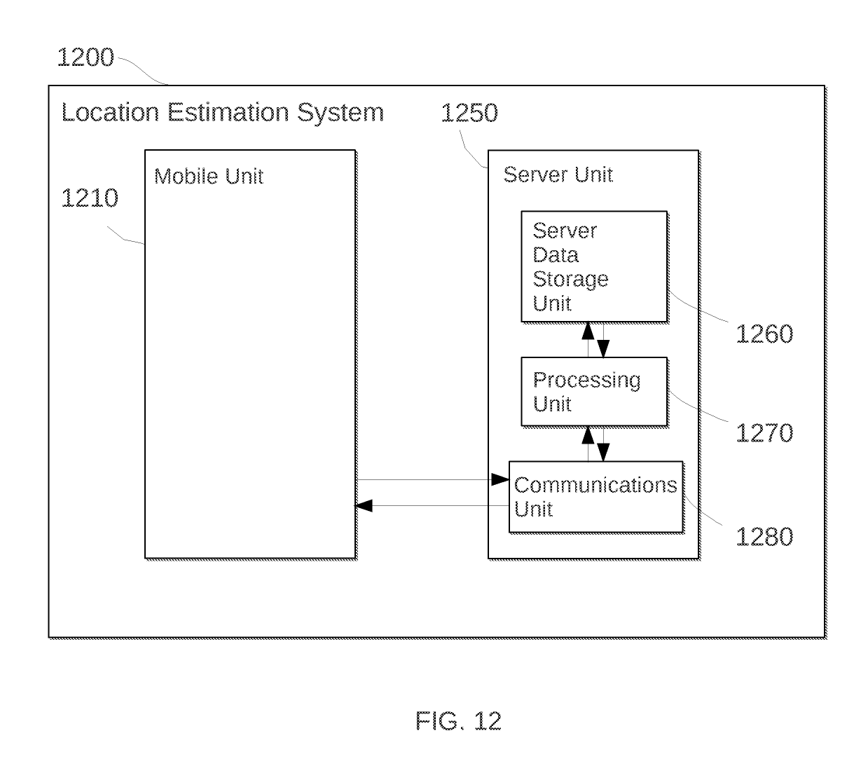

FIG. 12 is a block diagram illustrating functional components of a second exemplary location estimation system using categorized local location data from multiple sources. System 1200 can include mobile unit 1210 and server unit 1250. Unit 1210 contain the same components as system 1100 described in FIG. 11, except that the optional unit 1140 in system 1100 is required in unit 1210.

Unit 1250 contains server data storage unit 1260. Unit 1260 can be a non-transitory data storage component of unit 1250 that is configured to store those data in server data store 160 in reference to FIG. 1.

Unit 1250 contains processing unit 1270. Unit 1270 can contain one or more processors configured to perform operations 152, 154 and 156 in reference to FIG. 1.

Unit 1250 contains communications unit 1280. Unit 1280 can contain one or more network adapters configured to communicate with unit 1210 through a communications network.

What is claimed is:

1. A method implemented on a mobile device, comprising:
detecting, on said mobile device, one or more wireless access gateways;
for at least one detected wireless access gateway, determining whether or not location data of the wireless access gateway exists among part or all of a predetermined collection of data on said mobile device, said location data including a location estimate of said wireless access gateway, and none or at least one of:
an uncertainty value associated with said location estimate; or
a confidence value related to at least one of:
the likelihood that said wireless access gateway is stationary;
the likelihood that the true geographic location of said wireless access gateway is inside a geographic area defined by said location estimate; or
the likelihood that the true geographic location of said wireless access gateway is inside a geographic area defined by said location estimate and said uncertainty value; and
determining whether or not a condition related to location estimation of said mobile device is true.

2. The method of claim 1, further comprising:
determining a second location estimate of said mobile device, in response to the determination of said condition, using at least one of:
a signal from a navigation satellite;
data from another different computerized device; or
a first location estimate of said mobile device, determined using the existing location data on said mobile device of at least one of the detected wireless access gateways, and at least one of estimates of distances between said mobile device and said detected wireless access gateways.

3. The method of claim 2, further comprising at least one of:
updating the existing location data on said mobile device, of at least one detected wireless access gateway, using said second location estimate and none or at least one of:
an uncertainty value associated with said second location estimate;
an estimate of a distance between said mobile device and the detected wireless access gateway; or
said existing location data on said mobile device of said detected wireless access gateway; or
creating and storing on said mobile device, the location data of at least one detected wireless access gateway, using said second location estimate and none or at least one of:
a predetermined confidence value; or
an uncertainty value associated with said second location estimate, and an estimate of a distance between said mobile device and the detected wireless access gateway.

4. The method of claim 2, further comprising:
transmitting, through a predetermined communications network, a data request to a predetermined remote server;
receiving, from said remote server, through said or another predetermined communications network, location data of one or more server selected wireless access gateways;

5. The method of claim 4, further comprising:
updating the existing location data on said mobile device, of at least one of said server selected wireless access gateways, using their location data received from said server; or
creating and storing on said mobile device, at least one of the location data received from said server.

6. The method of claim 3, wherein said mobile device is a smart phone, a feature phone, a laptop, a wearable computing device, a tablet, or a portable digital sensor.

7. The method of claim 3, wherein said mobile device is a group of two or more communicatively connected computing devices, wherein at least one of said computing devices is a smart phone, a feature phone, a laptop, a wearable computing device, a tablet, a portable digital sensor, or other portable computing device.

8. The method of claim 3, wherein each detected wireless access gateway includes at least one of:
a cell tower;
a wireless router; or
an apparatus capable of emitting wireless signals.

9. The method of claim 3, wherein said location estimate of said wireless access gateway is a geographic point represented by a latitude coordinate and a longitude coordinate.

10. The method of claim 3, wherein said location estimate of said wireless access gateway is a geographic area represented by one or more geographic polygons expressed in GeoJSON format.

11. The method of claim 3, wherein said location estimate of said wireless access gateway includes a numerical or other code designating a predetermined geographic area.

12. The method of claim 3, wherein said uncertainty value indicates an estimation accuracy of said location estimate.

13. The method of claim 3, wherein said condition related to location estimation of said mobile device is determined to be true when and only when a value determined using the existing location data of the detected wireless access gateways satisfies a predetermined constraint.

14. The method of claim 3, wherein said condition related to location estimation of said mobile device is determined to be true when and only when a random value generated on said mobile device satisfies a predetermined constraint.

15. The method of claim 2, wherein said estimate of said distance between said mobile device and the detected wireless access gateway is based on one of:
a signal strength of a signal from said detected wireless access gateway;
a round-trip time of a signal between said mobile device and said detected wireless access gateway; or
a bit error rate of a signal between said mobile device and said detected wireless access gateway.

16. The method of claim 2, wherein determining said first location estimate comprises:
for each existing location data of a detected wireless access gateway, determining an intermediate location estimate of said mobile device using the existing location data and an estimate of a distance between said mobile device and said detected wireless access gateway; and
determining said first location estimate of said mobile device using the intermediate location estimates.

17. The method of claim 4, wherein said data request contains a number specifying the amount of location data requested.

18. The method of claim 4, wherein said data request contains said second location estimate of said mobile device.

19. The method of claim 4, wherein said data request contains identification information of one or more of said detected wireless access gateways.

20. The method of claim 4, wherein the received location data of said server selected wireless access gateways contain location estimates of said server selected wireless access gateways.
